(19) United States
(12) Patent Application Publication
(10) Pub. No.: US 2017/0198482 A1
(43) Pub. Date: Jul. 13, 2017

(54) PRECAST PANEL WITH PLASTERING-LIKE APPEARANCE

(71) Applicant: Kun-Lung TSOU, TAOYUAN CITY (TW)

(72) Inventor: Kun-Lung TSOU, TAOYUAN CITY (TW)

(21) Appl. No.: 14/993,450

(22) Filed: Jan. 12, 2016

(51) Int. Cl. E04F 13/08; B32B 5/16; B32B 21/04; B32B 7/12; B32B 13/04; B32B 19/04

(52) U.S. Cl. CPC E04F 13/0871; B32B 13/04; B32B 19/04; B32B 21/04; B32B 7/12; B32B 5/16; E04F 13/0866; B32B 2264/102; B32B 2264/10; B32B 2607/00

(57) ABSTRACT

A precast panel with plastering-like appearance is provided. The panel is built from a wooden substrate on which at least a mineral layer is prebuilt. When affixed to a wall, the wooden panel gives a visual effect simulating plastering. The panel has advantages inherited from its wooden substrate such as lightweight, economical and easy transportation, while exhibiting exclusive and fishable feeling like plastering, thereby serving as a low-cost yet high-quality choice for consumers.

### BACKGROUND OF THE INVENTION

1. Technical Field

The present invention relates to building materials, and more particularly to a precast panel with plastering-like appearance, wherein the precast panel is made of wood and has its appearance looks like plastering.

2. Description of Related Art

There are various building materials for used as wall finishing available in the market, such as wooden panels, stone slabs, tiles and wallpaper. While stone slabs are known to provide luxurious and exclusive decorative effects, they are expensive and require high transportation costs. On the other hand, wooden panels and wallpaper are not regarded as stylish in terms of visual effects although they are relatively economical. As industrial style are becoming a popular aesthetic trend for interior design, more and more designers like to decorate walls with plain plasterwork, which exhibits unpretentious, low-pitched yet fashionable feeling. However, whether the result of plasterwork is aesthetically good is highly dependent on workmanship of the plasterer creates it. A work form a less experienced or less skilled plasterer can self-defeatingly give dilapidated and strange feeling.

### SUMMARY OF THE INVENTION

For providing desired industrial style without the need of having a plasterer to work on site, it is one objective of the present invention to propose a precast panel with plastering-like appearance, wherein the prefabricated panel is lightweight and economical, while looking like plastering, thereby supporting a decorative preference for industrial style.

Another objective of the present invention is to provide the plastering-like panel that is prefabricated in the factory by the manufacturer for consistent quality and appearance as well as low manufacturing cost. The precast panel can be conveniently transported to the construction site and easily mounted onto a wall, so the construction period is minimized and the construction site is clean from additional dust.

For achieving the foregoing objectives, the present invention implements the scheme of building the panel from a substrate that has at least a mineral layer built thereon.

Preferably, the substrate is made of wood, but it can be instead made of cement or calcium silicate.

Preferably, the substrate has a prebuilt waterproof layer that keeps the substrate dry, and has an adhesive layer built on the waterproof layer. The mineral layer is built on the adhesive layer. The waterproof layer is made of a waterproof material. The adhesive layer is made of a binding material, so that the mineral layer and the waterproof layer can be combined firmly with the substrate. The mineral layer is made of cement, ore, sand, soil or any combination thereof. The mineral layer is covered by a protective layer, which is transparent or translucent and protects the mineral layer.

Alternatively, the substrate has a waterproof layer built thereon and then covered by a mineral layer that containing a composite binder. The binder-containing mineral layer is made of a mixture of a binding material and a mineral material. At last, the binder-containing mineral layer is covered by a protective layer, which is transparent or translucent and protects the mineral layer.

The mineral layer is made substantively planar, and provides a visual effect simulating cement surface in terms of texture and color as needed.

### BRIEF DESCRIPTION OF THE DRAWINGS

FIG. 1 is a perspective view of a precast panel according to one embodiment of the present invention.

FIG. 2 is an applied view of the precast panels of the present invention.

FIG. 3 is a perspective view of a precast panel according to another embodiment of the present invention.

### DETAILED DESCRIPTION OF THE INVENTION

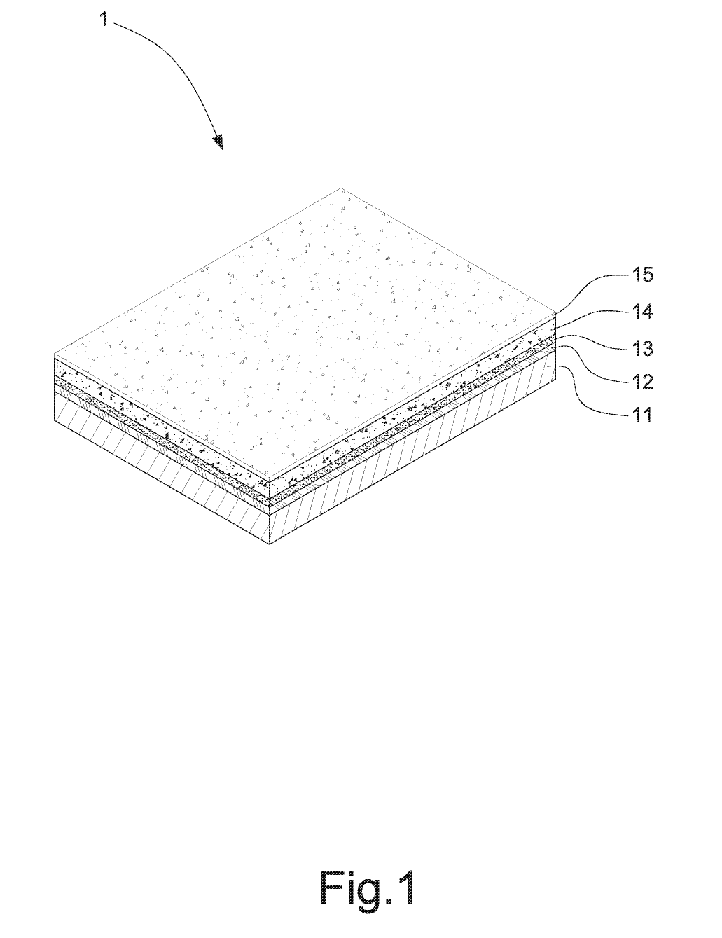

Referring to FIG. 1, in the present invention, a panel 1 is built from a substrate 11, on which a waterproof layer 12, an adhesive layer 13, a mineral layer 14 and a protective layer 15 are provided in sequence. Therein, the substrate 11 is preferably a wooden board, but it may alternatively be a cement slab or a calcium silicate board. The waterproof layer 12 serves to keep the substrate 11 dry and is made of a waterproof material. The adhesive layer 13 is made of a binding material for adhesion. The mineral layer 14 may be made of cement, ore, sand, soil or any combination thereof as long as it allows the adhesive layer 13 to adhere thereto. The protective layer 15 is either transparent or translucent, and serves to protect the mineral layer 14.

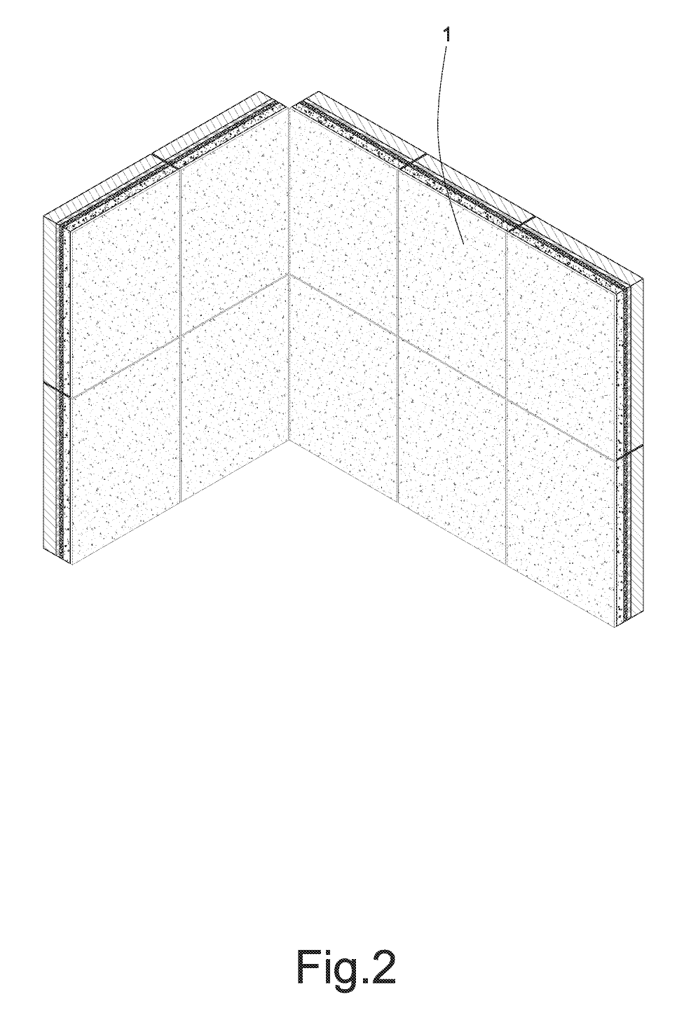

As shown in FIG. 1, with the wooden substrate 11, the disclosed panel 1 is lightweight and low-cost. Nevertheless, the external mineral layer 14 gives a plastering-like visual image. Thus, as the disclosed panel 1 is applied to building walls, as shown in FIG. 2, it desirably supports a decorative preference for industrial style.

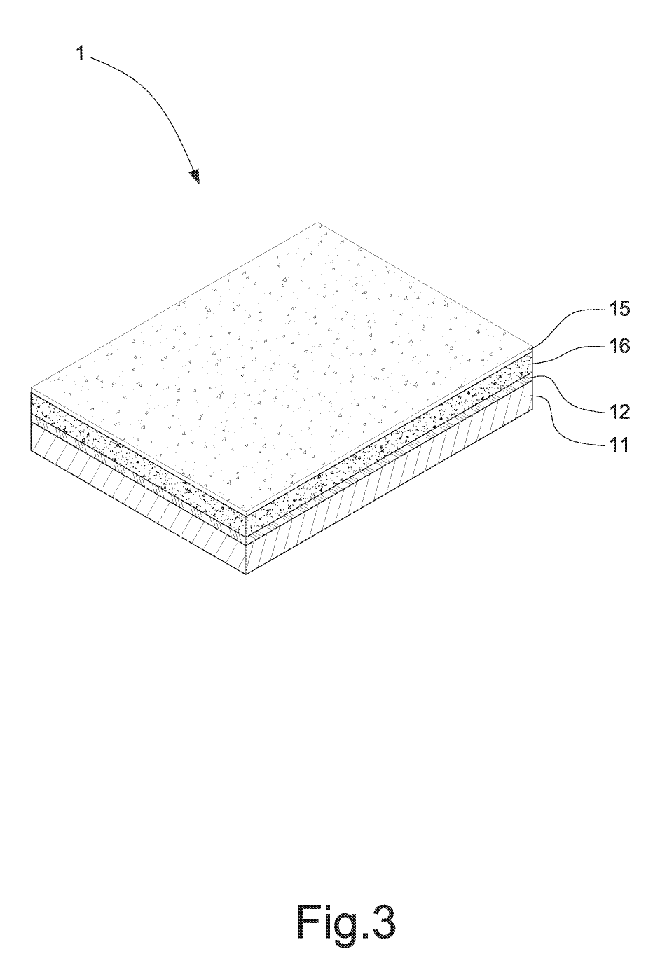

Now refer to FIG. 3 for another embodiment of the present invention. The panel 1 is such built that a substrate 11 is first covered by a waterproof layer 12, and the waterproof layer 12 is covered by a mineral layer 16 that contains a composite binder, after which the binder-containing mineral layer 16 is covered by a protective layer 15. The binder-containing mineral layer 16 is actually a combination of the adhesive layer 13 and mineral layer 14 as described in the previous embodiment.

The mineral layer 14 is made substantively planar, and provides a visual effect simulating cement surface in terms of texture and color as needed.

The present invention provides the following benefits:
First, the panel is lightweight so is easy to handle and transport.
Second, the panel is prefabricated in the factory in a mass manufacturing manner, thereby ensuring consistent quality and low costs.
Third, since the panel is premade, it can be quickly and easily fixed to the wall at the construction site, so the construction time is significantly reduced.

1. A precast panel with plastering-like appearance, the precast panel comprising:
a substrate;
a waterproof layer, directly disposed on an upper surface of the substrate;
an adhesive layer, combined on the waterproof layer;
a mineral layer, combined on the adhesive layer; and
a protective layer, combined on the mineral layer,
wherein the mineral layer is made of ore or soil or the combination thereof.

2. The precast panel of claim 1, wherein the substrate is made of wood, cement or calcium silicate.

3. The precast panel of claim 1, wherein the adhesive layer is a layer of binding material for adhesion.

4. (canceled)

5. The precast panel of claim 1, wherein the protective layer is transparent or translucent.
